(19) United States
(12) Patent Application Publication
(10) Pub. No.: US 2025/0209835 A1
(43) Pub. Date: Jun. 26, 2025

(54) DEEP LEARNING ENABLED OBLIQUE ILLUMINATION-BASED QUANTITATIVE PHASE IMAGING

(71) Applicant: Georgia Tech Research Corporation, Atlanta, GA (US)

(72) Inventors: Francisco E. Robles, Atlanta, GA (US); Paloma Casteleiro Costa, Atlanta, GA (US)

(21) Appl. No.: 18/852,175

(22) PCT Filed: Apr. 21, 2023
(86) PCT No.: PCT/US2023/066062

§ 371 Date: Sep. 27, 2024

Related U.S. Application Data
(60) Provisional application No. 63/363,427, filed on Apr. 22, 2022.

(51) Int. Cl. G06V 20/69; G02B 21/36; G06V 10/764; G06V 10/774; G06V 10/82

(52) U.S. Cl. CPC G06V 20/69; G02B 21/367; G06V 10/764; G06V 10/774; G06V 10/82; G06V 2201/03

(57) ABSTRACT

An exemplary embodiment of the present disclosure provides a quantitative phase imaging method, comprising: imaging a sample to obtain one or more raw captures: inputting the one or more raw captures into a deep learning neural network (DLNN); generating, using the DLNN, a quantitative phase image of the sample based on the one or more raw captures; and outputting the quantitative phase image.

### CROSS-REFERENCE TO RELATED APPLICATIONS

This application claims the benefit of U.S. Provisional Application Ser. No. 63/363,427, filed on 22 Apr. 2022, which is incorporated herein by reference in its entirety as if fully set forth below.

### GOVERNMENT LICENSE RIGHTS

This invention was made with government support under NS117067, and CA223853 awarded by the National Institutes of Health, and 1752011 awarded by the National Science Foundation. The government has certain rights in the invention.

### FIELD OF THE DISCLOSURE

The various embodiments of the present disclosure relate generally to quantitative phase imaging techniques.

### BACKGROUND

Label-free microscopy techniques such as quantitative phase imaging (QPI) have become vital in studying cells and biological processes over the past few decades. These techniques produce high-resolution phase maps of thin samples that reflect the specimens' refractive index and dry mass. As a result, QPI and other phase imaging tools have provided important information about cell growth and function, and have shed light on cell development. However, the application of these techniques is limited to thin samples because of their transmissive nature. Although 3D QPI techniques have been developed for tomographic imaging, their configurations generally remain transmission-based, restricting their use on thicker or in-vivo samples.

To overcome these limitations, the inventors hereof previously developed quantitative oblique back-illumination microscopy (qOBM) as a label-free, cross-sectional quantitative phase imaging technique using epi-illumination. This technique is disclosed in PCT Patent Publication No. WO2019/191061, which is incorporated herein by reference in its entirety as if fully set forth below. Using this technique, the inventors previously demonstrated the ability of qOBM to non-invasively image cord blood, identify brain tumor margins, study large organoids, and monitor 3D cell cultures in bioreactors.

Like many other QPI techniques, qOBM generally uses multiple acquisitions to extract the quantitative phase, which can hinder some applications. Precisely, qOBM can reconstruct the object's phase from two differential phase contrast images, which can be obtained by subtracting two captures taken from opposite directions, thus using a total of four captures to make one qOBM phase image. The speed of qOBM is thus greatly limited by the number of captures required per phase image. Accordingly, there is a need for improved qOBM techniques that can be performed more quickly and with fewer image captures.

### BRIEF SUMMARY

An exemplary embodiment of the present disclosure provides a quantitative phase imaging method, comprising: imaging a sample to obtain one or more raw captures; inputting the one or more raw captures into a deep learning neural network (DLNN); generating, using the DLNN, a quantitative phase image of the sample based on the one or more raw captures; and outputting the quantitative phase image.

In any of the embodiments disclosed herein, the one or more raw captures can consist of a first raw capture and a second raw capture orthogonal to the first raw capture.

In any of the embodiments disclosed herein, the one or more raw captures can consist of a first raw capture.

In any of the embodiments disclosed herein, the one or more raw captures can consists of a first raw capture taken at a first wavelength and a second raw capture taken at a second wavelength.

In any of the embodiments disclosed herein, the method can further comprise training the DLNN.

In any of the embodiments disclosed herein, the DLNN can comprise a generative adversarial network (GAN).

In any of the embodiments disclosed herein, the GAN can be an independent U-Net GAN.

In any of the embodiments disclosed herein, the GAN can comprise a discriminator and a generator, and training the DLNN can comprise: creating, with the generator, a plurality of fake training images; inputting the fake training images and a plurality of real images to the discriminator; and classifying, with the discriminator, the fake images from the real images.

In any of the embodiments disclosed herein, the generator can comprise 8 encoding layers and 8 decoding layers.

In any of the embodiments disclosed herein, training the DLNN can comprise training the DLNN to obtain a quantitative phase image from a single capture using a training data set to create a trained neural network.

In any of the embodiments disclosed herein, training the DLNN can comprise training the DLNN to obtain a quantitative phase image from a first capture and a second capture orthogonal to the first capture using a training data set to create a trained neural network.

In any of the embodiments disclosed herein, the sample can comprise one or more of blood tissue or brain tissue.

In any of the embodiments disclosed herein, the one or more raw captures can be oblique back-illumination microscopy (OBM) raw captures.

Another embodiment of the present disclosure provides a quantitative phase imaging system. The system can comprise a camera and a deep learning neural network (DLNN). The camera can be configured to take one or more raw captures of a sample. The DLNN can be configured to receive as an input the one or more raw images and generate, based on the one or more raw images, a quantitative phase image of the sample.

In any of the embodiments disclosed herein, the GAN can comprise a discriminator and a generator, the generator can be configured to create a plurality of fake training images, and the discriminator can be configured to classify the plurality of face training images and real images.

In any of the embodiments disclosed herein, the DLNN can be trained to obtain a quantitative phase image from a single capture using a training data set.

In any of the embodiments disclosed herein, the DLNN can be trained to obtain a quantitative phase image from a first capture and a second capture orthogonal to the first capture using a training data set.

In any of the embodiments disclosed herein, the camera can be configured to take oblique back-illumination microscopy (OBM) raw captures of the sample.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIGS. 1A-F provide images of the results of TC-qOBM and SC-qOBM reconstructions, in accordance with some embodiments of the present disclosure. FIGS. 1A-B provide qOBM images of blood and rat brain, respectively, reconstructed from four captures and reconstructed through a regularized Tikhonov deconvolution. FIGS. 1C-D provide TC-qOBM model output from two raw captures. FIGS. 1E-F provide SC-qOBM model output from one raw capture. The scale bar is 50 μm.

FIGS. 2A-B illustrate a quantitative phase imaging method utilizing two raw captures and a single raw capture, respectively, in accordance with some embodiments of the present disclosure.

FIG. 3 illustrate a quantitative phase imaging method, in accordance with some embodiments of the present disclosure.

FIG. 4 provides a computing device that can be used with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having.” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

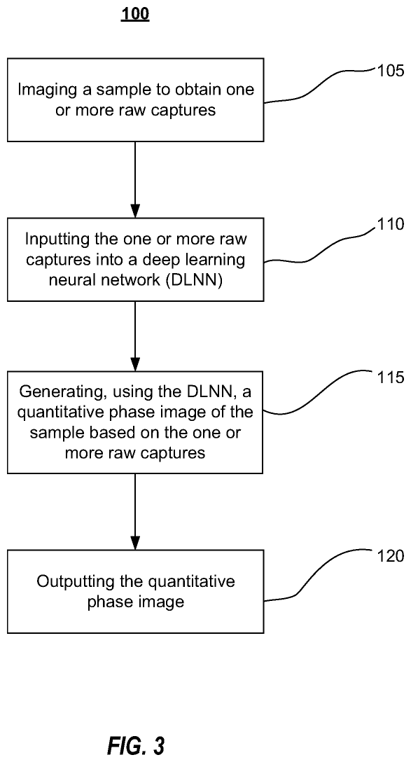

As described above, a problem with current QPI techniques is that it typically requires processing multiple image acquisitions to obtain a desired image. To address this important challenge, the present disclosure provides systems and methods for imaging samples using a deep learning neural network (DLNN). For example, as shown in FIG. 3, an exemplary embodiment of the present disclosure provides a quantitative phase imaging method 100, comprising: imaging a sample to obtain one or more raw captures 105; inputting the one or more raw captures into a deep learning neural network (DLNN) 110; generating, using the DLNN, a quantitative phase image of the sample based on the one or more raw captures 115; and outputting the quantitative phase image 120.

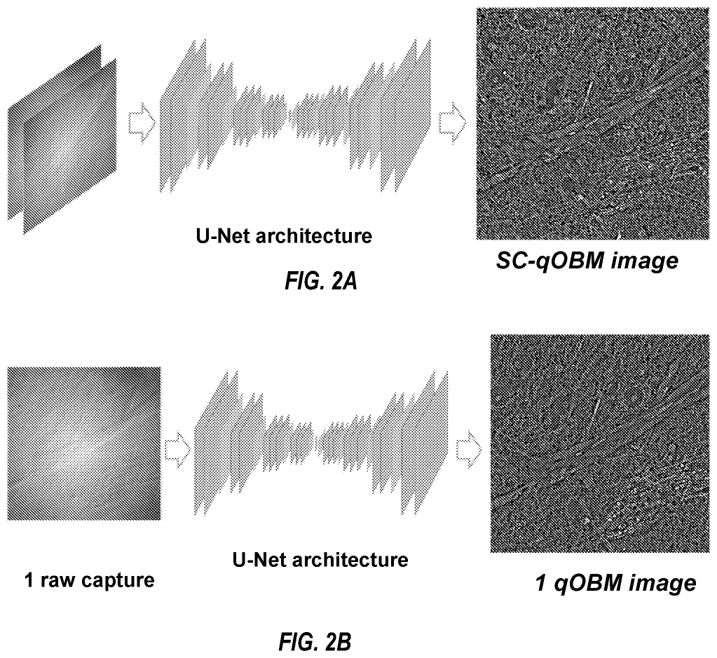

The one or more raw captures can be taken utilizing a camera, such as an oblique illumination microscopy camera system. In some embodiments, the camera can be an oblique back-illumination microscopy camera system. Various embodiments of the present disclosure can utilize one, two, or more raw captures. For example, in some embodiments, as shown in FIG. 2A, two raw captures can be input into the DLNN-a first raw capture and a second raw capture orthogonal to the first raw capture (e.g., with a net oblique illumination of 0 and 90 degrees). Additionally, in some embodiments, as shown in FIG. 2B, only a single raw capture is input into the DLNN. As those skilled in the art would appreciate, the use of only a single raw capture can increase processing speed, which can provide for more applications, while the use of two raw captures can ensure that the inputs contain all frequency content needed to recover the phase with high fidelity in all directions. In some embodiments, two raw captures can be input into the DLNN in which each raw capture is taken at a different wavelength (e.g., red and green).

The DLNN can be many different neural networks. In some embodiments, the DLNN can comprise a generative adversarial network (GAN), such as a U-Net GAN, that can be used to train the DLNN. The GAN can comprise a discriminator and a generator. The generator can create a plurality of fake training images. The discriminator can receive the fake images and real images and seek to classify the images accordingly to train the DLNN.

The generator can comprise any number of encoding and decoding layers, as those skilled in the art would understand. For example, in some embodiments, the generator can comprise eight encoding layers and eight decoding layers.

The systems and methods disclosed herein can be used for imaging many different biological samples, including, but not limited to, blood tissue, brain tissue, and the like.

Once the quantitative phase image of the sample is generated, the method can further comprise outputting the quantitative phase image 120. The image can be output to many different locations. For example, in some embodiments, the image can be output and stored in memory, transmitted to a remote device, displayed on a display, and the like.

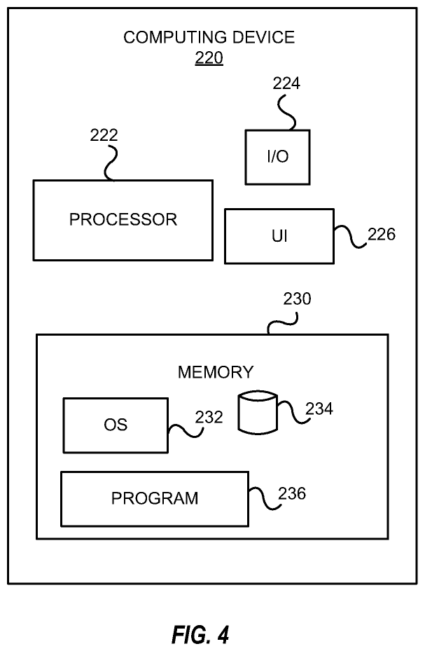

FIG. 4 illustrates an exemplary computing device that can be used to implement the methods (or one or more steps of the methods) disclosed herein. As will be appreciated by one of skill in the art, the computing device 220 can be configured to implement all or some of the features described in relation to the methods 1000 1100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. The processor 222 may also comprise multiple processors, each of which is configured to implement one or more features/steps of the disclosed technology. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be configured to store the software repository 102 or data generated by the repository intent model 104 such as synopses of the computer instructions stored in the software repository 102, inputs received from a user (e.g., responses to questions or edits made to synopses), or other data that can be used to train the repository intent model 104.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

Disclosed below are certain examples to explain the various embodiments of the present disclosure. These examples are for explanatory purposes only and should not be construed as limiting the scope of the disclosure.

### EXAMPLES

qOBM System Design and Image Reconstruction

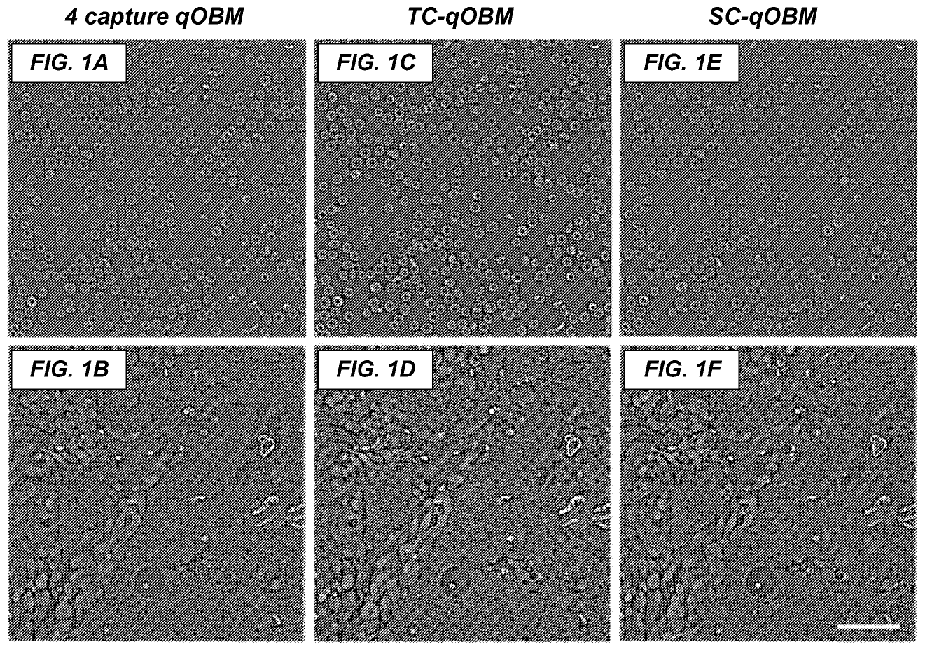

The qOBM system comprises an inverted microscope with a modified illumination scheme. This scheme comprises four multimode fiber optics (1 mm core, 0.5 NA) positioned at a 45-degree angle around the objective (60× magnification, 0.7 NA). Each fiber has an LED coupled to it. The LEDs illuminate the sample sequentially and an oblique back-illumination microscopy (OBM) capture is acquired. With four OBM captures, a qOBM image (FIG. 1A-B) can be reconstructed by deconvolving the data with the optical transfer function of the system, following a regularized Tikhonov deconvolution.

### Neural Network Architecture and Training

The training process was performed through GAN, which includes a generator and discriminator. The generator serves the purpose of performing the quantitative phase reconstruction. The architecture of the generator was that of a U-Net with eight encoding layers and eight decoding layers. The discriminator was a classifier that attempts to identify real (ground truth) and fake (U-Net output) images. The training was performed using the PyTorch deep learning library on Python.

For the training process, the data was cropped in regions of 256×256 pixels, corresponding to 35×35 μm. The data was split into training and testing images, with 70% left for training and the remaining 30% for testing. The networks were trained over 20 epochs.

The training process was independently performed for two types of samples: blood and rat brain. Two versions of this algorithm were evaluated. For the first approach, called two capture qOBM (TC-qOBM), the input data consisted of two raw OBM captures, obtained from illuminating the sample in perpendicular directions. This model is expected to perform well because the input data contains phase information in all directions. The second model, called single capture qOBM (SC-qOBM), receives one single OBM raw capture as input and reconstructs the quantitative phase. The results of the SC-qOBM and TC-qOBM reconstructions can be seen in FIG. 1.

### Results

Examples from the testing sets of the reconstruction of the quantitative phase from two and one raw captures can be seen in FIGS. 1C-D and FIGS. 1E-F, respectively. The reconstructed images are nearly identical to the ground truth reconstructed from four captures.

In order to evaluate the performance of the models, metrics, such as the mean square error (MSE), were calculated to understand the quantitative correctness of the reconstructions, and the structure similarity index measure (SSIM), to evaluate the structural integrity of the new reconstructions. The benchmarks show very encouraging results, with MSE values of 0.003 and 0.004 for blood and brain TC-qOBM, respectively, and SSIM values of 0.89 and 0.9 for blood and brain TC-qOBM testing data. The SC-qOBM metrics are also encouraging, with an MSE of 0.007 and 0.012 for blood and brain, respectively, and an SSIM of 0.72 in the blood data and 0.78 in the brain data.

These results are highly promising. Without wishing to be bound by any particular scientific theory, the single-capture reconstruction framework can be sample-dependent, but this can be related to sample structure, optical properties, or both. These considerations can be discussed in detail. The capabilities of this method to image more complex samples can also be presented. A single-capture qOBM reconstruction can have significant implications for qOBM, enabling simpler imaging protocols, eliminating motion artifacts, and allowing investigation of fast dynamic processes.

Furthermore, the conversion of single capture oblique illumination images to quantitative phase can be generated from a transmission system, as well as an epi-mode system using back-illumination (as with OBM and qOBM).

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A quantitative phase imaging method comprising:
imaging a sample to obtain one or more oblique illumination raw captures;
inputting one or more of the oblique illumination raw captures into a deep learning neural network (DLNN); and
generating, using the DLNN, a quantitative phase image of the sample based on the inputted oblique illumination raw captures.

2. The method of claim 1 further comprising:
outputting the quantitative phase image;
wherein two of the oblique illumination raw captures comprise a first oblique illumination raw capture and a second oblique illumination raw capture orthogonal to the first oblique illumination raw capture.

3. (canceled)

4. The method of claim 2, wherein the first oblique illumination raw capture is taken at a first wavelength and the second oblique illumination raw capture is taken at a second wavelength.

5. The method of claim 2 further comprising training the DLNN.

6. The method of claim 5, wherein the DLNN comprises a generative adversarial network (GAN).

7. The method of claim 6, wherein the GAN is an independent U-Net GAN.

8. The method of claim 6, wherein:
the GAN comprises a discriminator and a generator; and
training the DLNN comprises:
creating, with the generator, fake training images;
inputting at least a portion of the fake training images and real images to the discriminator; and
classifying, with the discriminator, the fake images from the real images.

9. (canceled)

10. The method of claim 1 further comprising training the DLNN to obtain the quantitative phase image from a single oblique illumination raw capture using a training data set to create a trained neural network.

11. The method of claim 5, wherein training the DLNN comprises training the DLNN to obtain the quantitative phase image from the first oblique illumination raw capture and the second oblique illumination raw capture using a training data set to create a trained neural network.

12. The method of claim 1, wherein the sample comprises at least one of blood tissue or brain tissue.

13. (canceled)

14. A quantitative phase imaging system comprising:
an imager configured to take one or more quantitative oblique back-illumination microscopy (qOBM) raw captures of a sample;
a processing resource; and
a non-transitory computer-readable medium, coupled to the processing resource, having stored therein instructions that when executed by the processing resource cause the processing resource to:
generate, based on one or more of the gOBM raw images, a quantitative phase image of the sample using a deep learning neural network (DLNN) trained to obtain the quantitative phase image using incoherent illumination from one or more of the gOBM raw images.

15. The system of claim 14, wherein two of the gOBM raw captures comprise a first gOBM raw capture taken at a first wavelength and a second gOBM raw capture taken at a second wavelength and orthogonal to the first gOBM raw capture.

16.-17. (canceled)

18. The system of claim 14, wherein the DLNN comprises a generative adversarial network (GAN).

19. The system of claim 18, wherein the GAN is an independent U-Net GAN.

20. The system of claim 18, wherein:
the GAN comprises a discriminator and a generator;
the generator is configured to create fake training images; and
the discriminator is configured to classify the fake training images from real images.

21. The system of claim 20, wherein the generator comprises 8 encoding layers and 8 decoding layers.

22.-23. (canceled)

24. The system of claim 14, wherein the sample comprises at least one of blood tissue or brain tissue.

25. A quantitative phase imaging system, comprising:
an imager configured to take one or more raw captures of a sample;
a processing resource; and
a non-transitory computer-readable medium, coupled to the processing resource, having stored therein instructions that when executed by the processing resource cause the processing resource to:
generate, based on one or more of the raw images, a quantitative phase image of the sample using a deep learning neural network (DLNN) trained to obtain the quantitative phase image from one or more of the raw images;
wherein the imager is a camera configured to take oblique back-illumination microscopy (OBM) raw captures of the sample.

26. The system of claim 25, wherein:
the imager uses incoherent illumination and comprises:
light sources comprising light-emitting devices; and
an image-capturing device; and
the light sources illuminate the sample sequentially and the oblique back-illumination microscopy (OBM) raw captures are acquired by the image-capturing device.
